(19) United States
(12) Patent Application Publication
(10) Pub. No.: US 2006/0249530 A1
(43) Pub. Date: Nov. 9, 2006

(54) Dispenser with sound and motion

(75) Inventor: Mark Ho, Taipei (TW)

Correspondence Address: FROMMER LAWRENCE & HAUG, 745 FIFTH AVENUE- 10TH FL., NEW YORK, NY, 10151, US

(73) Assignee: Allure Home Creations Co., Inc.

(21) Appl. No.: 11/124,447

(22) Filed: May 6, 2005

(51) Int. Cl. B67D 5/00; B05B 11/00

(52) U.S. Cl. 222/39; 222/78

(57) ABSTRACT

A dispenser including a decorative housing, fluid storage internal to the decorative housing, and a fluid dispenser in fluid communication with the fluid storage. The dispenser also includes one or more movable decorative elements, an activator in communication with the fluid dispenser, and a sound emitter. Upon operation of the fluid dispenser fluid is dispensed from the fluid storage and the activator is triggered initiating the sound emitter to produce sound and further initiating movement of one or more moveable decorative elements.

### INCORPORATION BY REFERENCE

All documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

1. Field of the Invention

The present invention relates to a dispenser having a sound emitting device and movement capabilities.

The invention relates to such a dispenser wherein the dispenser portion thereof can be any pressure-activated dispenser. Such a pressure-activated dispenser can involve a point on the dispenser to which a user applies pressure; for instance, to depress an activator or pump. The pressure-activated dispenser may be set relatively stationary on a surface, such as a sink, countertop, dresser, or the like. By depressing the activator or activation switch, the user closes an electrical circuit which causes the dispenser to emit a sound, such as a song and or alternatively causes portions of the dispenser to move.

The dispenser can generate a sound that is consistent with the sound that would be made by the shape depicted by the pump dispenser, when the dispenser is activated and thus, entertain users of the dispenser. For example, if the dispenser is shaped like a cow, it can emit a “moo” sound when the dispenser is activated. Thus, the invention relates to dispensers that can be entertaining.

Further, the ability of the dispenser to emit a sound when activated can assist those who are blind or visually impaired; for instance, by emitting a sound when the dispenser is activated, a blind or visually impaired person can have sound or audio confirmation that the liquid was dispensed. And moreover, that person can have different dispensers for different liquids; for example, hand soap can be shaped like a cow and emit a “moo”, toothpaste can be a cat and emit a “meow” and cologne can be a “rooster” and emit a “cock-a-doodle do”, such that when the visually-impaired person wants soap, if he hears a “moo”, he knows he has dispensed soap into his hand, whereas if he hears the “meow” of the cat or the crow of the rooster, he knows he does not have soap. Alternatively and/or additionally, the dispenser can play music; for example, a “cow” could play “Hey Diddle Diddle”, or be otherwise shaped and emit music (e.g., be shaped like a baseball bat and play “Take Me Out To The Ballpark” or be shaped otherwise, e.g., like a musical instrument, and play a portion of a song, melody or tune).

Or, alternatively and/or additionally, the dispenser can include a sound emitting device that emits a word or phrase, such as “soap” with the dispenser including that word or phrase on its outer surface so that it can be seen or felt or both by the user, e.g., raised letters, such as raised Braille letters or raised enlarged letters for those who visually read, so as to assist a blind or visually impaired person; or to be an educational tool for a child. The dispenser can be in a decorative shape and the word or phrase can be an identifying word or phrase, e.g., the dispenser can be shaped like a cow and emit the word “cow”, and/or also have that word on it, so that the dispenser can be an educational tool.

Even further still, the invention can relate to such a dispenser wherein there is a VOX, and in response to a sound such as that of the flow of water in a sink or the flush of a toilet, the sound emitting device emits a sound, such as a phrase, e.g., “remember to wash hands” or “remember to brush teeth”; and, when activated thereafter, it can emit a different sound such as a phrase, e.g., “soap” or “toothpaste” and/or “good job”, and/or the dispenser can also have a word on its outer surface, e.g., “soap” or “toothpaste” to thereby encourage use of sanitary products and sanitary behavior by younger users and/or to be an educational tool.

Accordingly, the invention can relate to dispensers that are educational tools, e.g., promote good sanitary or other behavior and/or teach a word and/or assist those who are blind or visually impaired and/or that are entertaining.

The invention also relates to methods for making and using such a dispenser, as well as methods of making and using components of such a dispenser for constructing and using the dispenser.

2. Background of the Invention

Dispensers for liquids, particularly for cleansing solutions such as shampoo, are dispensed from open-mouthed bottles, but, open-mouthed bottles do not allow the user to dispense a particularly amount.

Dispensers for liquids are varied. Cleansing solutions such as shampoo are dispensed from open-mouthed bottles, but open-mouth bottles do not allow the user to dispense a particular amount.

There are also pump-type dispensers. Conventional pump-type dispensers include a pumping means having dispensing tube and an actuator. A user depresses the actuator which forces gas into the dispensing tube and into a stationary bottle (with respect to the actuation or pump nozzle). This creates a vacuum that forces the liquid in the bottle to rise within a tube and exit from the actuator. The actuator of a pump-type dispenser is typically positioned at the top of the bottle. Pump-type dispensers are also used to dispense liquids such as cleansing solutions, (e.g., shower gel, shampoo) or lotions or hair conditioner. The actuator that serves as a dispensing means can be a conventional pump-type activator, it can also be an activator with a nozzle or an aerosol activator.

In many ways a different and novel dispenser for liquids, preferably for cleansing solution, lotion, shower gel, shampoo, conditioner or the like, is desired. The appearance or design of a dispenser is desirably aesthetically pleasing and if possible to entertain the user young or old.

However, meeting these desires has been hampered by the functional limitation of the pump spray dispenser, namely, that the actuator must be depressed to deliver the liquid.

Presently available dispensers for shower gel or for shampoo are predominantly made from blow-molding a container; a dispensing/actuator mechanism removably attaches at the top the container to allow refilling (e.g., via threads at the top of the container). The dispensers can have a design printed on the outer surface of the container, or animals or cartoon characters on top of the actuators, to make the dispenser attractive. However, these dispensers do not provide any decorative value once emptied. These dispensers are generally not useful as a decoration. Thus, the end result is that these dispensers are discarded thus, creating an adverse effect on the environment. Accordingly, it would be desirable to provide an aesthetically pleasing dispenser which would encourage the user to reuse it, and therefore reduce the burden on the environment by users summarily discarding dispensers when empty.

Although a sculptured dispenser is commonly available, sculpted dispensers are not interactive. It would be desirable if a dispenser, when activated to dispense, can generate a sound or music or phrase or the like; thus, for instance, as to younger users, the dispenser can encourage them to wash their hands, and/or for the older or visually impaired users, the dispenser can let them know the contents in the dispenser, and/or for all other general users, the sound emitting liquid dispenser can provide some entertaining dialogue, music, or sound (as in the present invention). Furthermore, once the liquid in the dispenser is exhausted, the dispenser can be used as a household decorative item or the reservoir where the liquid is disposed of can be refilled which will evidently decrease the production of non-biodegradable waste.

Another desirable function that may be particularly pleasing to younger users would be to have the dispenser conduct some motion following activation. That is for example, a dispenser in the shape of a dog may wag its tail. It is possible that such wagging could be coupled to the sound emitting element to cause the dispenser to Bark or sing a song while the tail is wagging. Other desirable movements include movement of lips to indicate singing, swimming motion of for example a fish, rolling of eyes, rocking of a horse, pecking by a chicken, dancing or rotating. Such actions may desirably be in time with or separated from sound or music eminated from the sound emitting element.

With respect to dispensers, reference is made to the following:

U.S. Pat. No. 5,258,209 Bankert et al. relates to a decorative device for displaying an ornamental object within a fluid. The device takes the form of a transparent hollow bell-shaped enclosure, the interior of the enclosure containing a fluid and a plurality of small particles. A handle is attached to the crown of the enclosure. A fluid tight base is sealingly connected to the mouth of the enclosure.

Luu, U.S. Pat. No. 5,301,836, is directed to a liquid dispenser having movable head as pump actuator. More specifically, a plastic container in the shape of an animal body for holding liquid.

Litton et al., U.S. Pat. No. Des. 318,794, provides an ornamental design for a combined bottle and cap.

Dinand, U.S. Pat. No. Des. 365,020, relates to an ornamental design for a combined cosmetic container and cap.

Maddox, U.S. Pat. No. Des. 346,548, is directed to an ornamental design for a combined pump dispenser and cap.

Kuzma, U.S. Pat. No. Des. 348,388, is concerned with an ornamental design for a pump dispenser.

Crawford, U.S. Pat. No. Des. 370,636, is directed to an ornamental design for the body for a bottle.

Costa, U.S. Pat. No. Des. 352,234, relates to an ornamental design for a pump dispenser.

Crawford, U.S. Pat. No. Des. 376,310 provides an ornamental design for a bottle.

Each of these patents provides either a dispenser or a fluid-containing device for displaying an ornamental object within the fluid. None of these patents discloses or suggests a dispenser that emits a sound when activated.

Another patent to which reference is made is Shu, U.S. Pat. No. 6,315,163, which describes a two-piece dispenser comprised of a base and a dispenser, wherein upon application of pressure to the dispenser a sound-emitting element in the base is triggered. However, such a device requires two components, and does not describe movement of any portions of the device.

Thus, it is believed that heretofore the present invention has not been taught or suggested.

### SUMMARY OF THE INVENTION

It is therefore an object of the invention to provide a novel dispenser.

It is also an object of the invention to provide a dispenser which is suitable for dispensing a lotion, shampoo, detergent, liquid soap, conditioner or the like.

It is yet a further object of the invention to provide a dispenser that is interactive with its user and/or that emits a sound, noise, phrase, music, or the like, when activated to dispense.

It is yet a further object of the invention to provide a dispenser which moves when activated to dispense. Examples of such movement include swimming motion for a fish, wagging of tail by a dog, rolling of eyes by a monkey, etc.

It is still yet another object of the invention to provide a dispenser having a sculptured appearance wherein the sound generated and the motion correspond with the appearance of the sculpture. For example, if the dispenser is in the shape of a cat, then the sound generated would be consistent with that made by a cat (e.g., “meow,” “hiss,” “purr”). Similarly, the motion may correspond with the appearance of the sculpture, wherein a dog may wag its tail, while barking or panting.

Thus, the present invention provides a dispenser including a sound emitting device; for instance, a pressure-activated dispenser including a sound emitting device wherein pressure for dispensing from the dispenser also activates the sound emitting device; e.g., pressure for dispensing is translated through the pressure activated dispenser to provide pressure to the sound emitting device and thereby activate it. Accordingly, the invention can provide a sound emitting and dispensing device comprising: a pressure-activated dispenser; and a pressure-activated sound emitting device; whereby the pressure-activated dispenser and the pressure-activated sound emitting device are connected and pressure activating the dispenser activates the sound emitting device. The dispenser and the sound emitting device can be connected in such a manner that they are directly in contact with each other, or otherwise, e.g., whereby they are indirectly connected—an intervening member, piece or element prevents direct contact but allows for transmission of pressure that is for activating the dispenser to also activate the sound emitting device.

Accordingly, in an embodiment the present invention provides a sound emitting dispenser for dispensing a fluid such as a liquid and for emitting a sound, in response to pressure, e.g., for dispensing liquid from a pump nozzle bottle having a pump nozzle from which liquid dispenses, the dispenser including a container, vessel or bottle to which is connected the pump nozzle (actuator). Wherein when the actuator of the dispenser is activated, the pressure of activation of the dispenser can cause the dispenser to come into contact with the sound emitting device so as to cause the liquid to dispense from the pump nozzle and at the same time activate the sound emitting device to generate a sound, such as a pre-programmed sound.

In another embodiment, when the actuator of the dispenser is activated, the pressure of activation of the dispenser can cause an electrical circuit to close causing the dispenser to conduct a predetermined series of motions, such as a swimming motion by a fish.

In another embodiment, the dispenser is sculptured to resemble an animal, such as a member in the fish family (e.g., goldfish, tropical fish), or a member in amphibian family (e.g., frog, toad, salamander), or a member in the reptile family (e.g., crocodile, alligator, turtle, tortoise), a member of the bird family (e.g., duck, goose, crow, rooster, chicken) or a member in the mammal family (e.g., cow, cat, dog, sheep, lamb, rabbit, hare). Advantageously, the dispenser is in a form selected from the group consisting of: a dog, a cat, a rooster, a duck, a dolphin, a cow, a tiger, a rabbit, a dragon, a snake, a horse, a sheep, a monkey, a pig, an insect (e.g., bee, fly, ladybug, ant, butterfly) and a seal; or, the dispenser is in a form dispenser of a plant or of an inanimate object, such as a tree, a mountain, and a flower, an electrical appliance, a locomotive or train, a car, an airplane, a jet, a space shuttle, a truck, a car (or generally, transportation means), a volcano, a building or structure (e.g., a house a building or structure such as the Eiffel Tower, the World Trade Center, etc.), a sport equipment (bat, ball, hockey stick, etc), furniture, or any and all other inanimate object, animate object, animal, etc. For instance, the dispenser can be shaped like a caricature of a famous person or character, and the sound emitting device can emit a quote or phrase from that person or character (e.g., a “Clint Eastwood” or “Dirty Harry” or “George Bush” dispenser that emits the phrase “Read My Lips” when activated, or a “Bugs Bunny” dispenser that emits the phrase “What's Up Doc?” when activated, and the like). And thus, the pressure activated sound emitting device can advantageously produce a sound that is consistent with the appearance of the sculptured dispenser.

In one preferred embodiment the dispenser includes a decorative housing, a fluid storage means internal to the decorative housing, and a fluid dispensing means in fluid communication with the fluid storage means. The dispenser of a preferred embodiment also includes one or more movable decorative elements, an activation means in communication with the fluid dispensing means, and a sound emitting means. Upon operation of the fluid dispensing means fluid is dispensed from said fluid storage means and the activation means is triggered initiating the sound emitting means to produce sound and further initiating movement of one or more moveable decorative elements.

In this text, the terms “comprising”, “comprise”, “comprises” and other forms of “comprise” can have the meaning ascribed to these terms in U.S. Patent Law and can mean “including”, “include”, “includes” and other forms of “include”.

These and other objects and embodiments of the invention are provided in, or are obvious from, the following detailed description of the invention.

### BRIEF DESCRIPTION OF THE DRAWINGS

In the following detailed description of the invention, reference will be made to the accompanying drawings, incorporated herein by reference, wherein:

FIG. 1 shows an external side view of a dispenser in accordance with one aspect of the present invention.

FIG. 2 shows a cross-sectional side view of a dispenser according to one aspect of the present invention.

FIG. 3 shows a top view of a dispenser according to one aspect of the present invention.

FIG. 4 shows a profile view of a tumbler in accordance with one aspect of the present invention.

FIGS. 5-8 show perspective views of a duck, dog, cow, and monkey respectively, in accordance with the present invention.

FIG. 9 shows an internal view of an embodiment of the present invention shown in FIG. 8.

### DETAILED DESCRIPTION

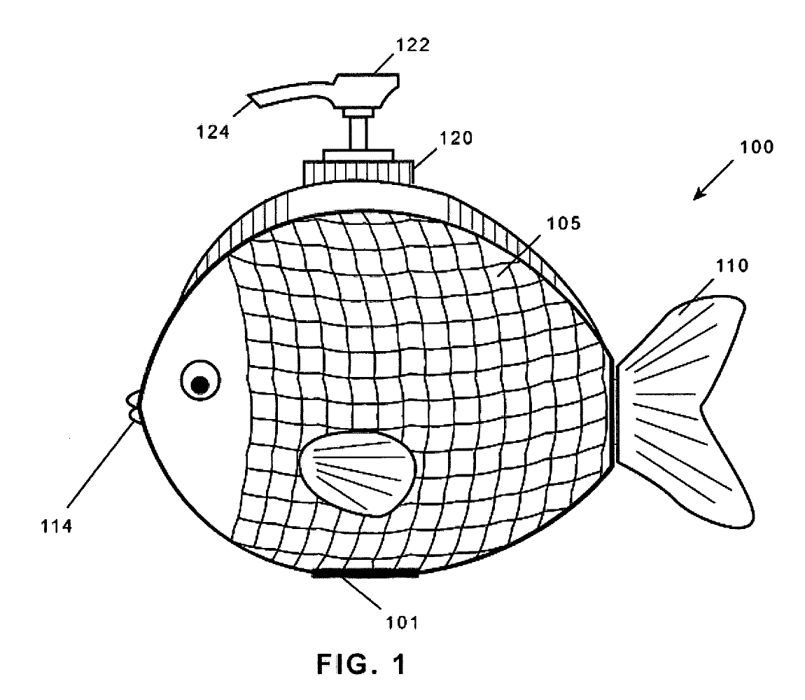

FIG. 1 depicts a dispenser 100 according to one embodiment of the present invention. The dispenser 100 of FIG. 1 is in the shape of a fish, however, other shapes including for example other animals, toys such as cars and trucks, as well as other decorative shapes may be utilized without departing from the scope of the present invention. As shown in FIG. 1, the outer housing 105 of dispenser 100 has a decorative exterior that is colored and shaped to look like the body of a fish. The dispenser 100 has a flat region 101 on its lower surface that it can rest on when placed on a countertop, shelf, sink, or the like. The dispenser 100 may have, as shown in FIG. 1, one or more appendages or movable decorative elements including for example the rear tail 110, side fins 112, lower lip 114. A fluid dispensing means such as a pump 122 may be included. As shown in FIG. 1 the pump 122 extends from and is integral with a cap 120 which is used to seal the dispenser 100. In the embodiment of FIG. 1 the pump 122 protrudes from cap 120, such that when the pump 122 is depressed, fluid stored within the dispenser 100 is pumped out of the dispenser and exits through an orifice 124 in the pump 122.

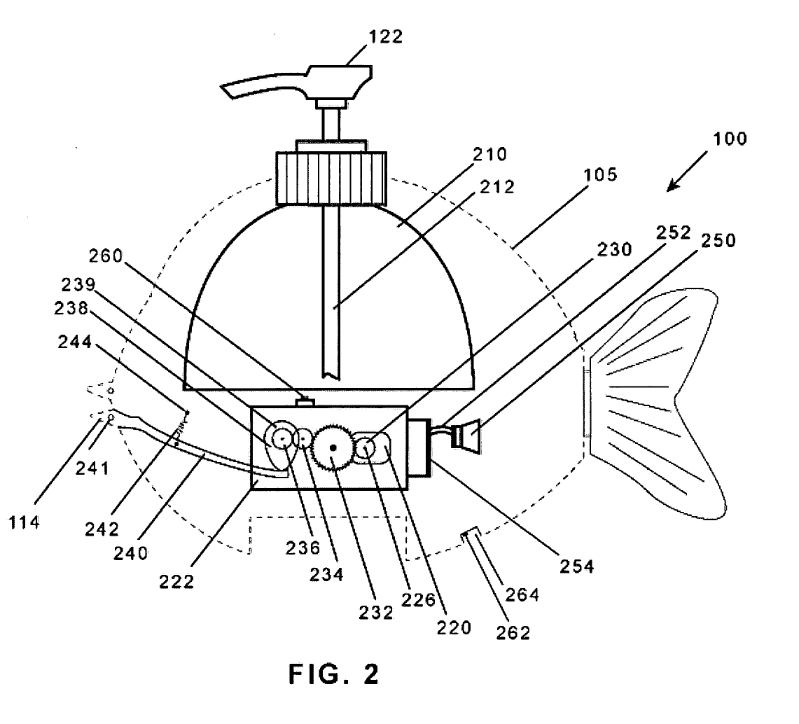

FIG. 2 is a cross sectional view of the dispenser 100 shown in FIG. 1. The dispenser 100 includes a storage space 210 which is usable to store a fluid or fluidizable substance. Typical fluids include lotion, liquid soap, toothpaste, or the like, however, the invention is no so limited and may be used to store fluidizable substances such as powders including pressurized aerosols that may contain a mixture of solid and liquid components. In the embodiment shown in FIG. 2 a tube 212 extends into storage space 210 and is in fluid communication with pump 122.

According to one embodiment of the present invention a motor or other driving means 220 may be mounted within a housing 222. The housing 222 is located within the dispenser 100. The driving means 220 may be powered by a power source, not shown, for example by a battery that is housed in a compartment 224 (shown here without removable cover). As shown in FIG. 2, a shaft 226 driven by the driving means 220 is attached to a gear 230, which is in communication with gears 232, 234, and 236. Gear 236 is attached to eccentric cam 238, and fin driver pin 239 protrudes from the face of eccentric cam 238. Thus when driven by the driving means 220, the gear train causes one or more side fins 112 to be activated in a robotic fashion As further shown in FIG. 2, one or more lips 114 may be attached to one or more lever arms 240. The lips 114 and lever arm 240 pivot around pin 241. The pin 241 may be attached at any desirable point along the length of the lever arm 240. In one embodiment a spring 242 is attached to lever arm 240. The spring 242 provides spring force to maintain the end of the lever arm 240 distal from the lips 114 in contact with the cam 238. The other end of spring 242 is attached to an anchor 244 that may be located on the inside of the outer housing 105, optionally, the anchor 244 may be located on the surface of motor housing 222.

The dispenser 100 may also contain a sound emitting device 250 such as a speaker. In one embodiment the sound emitting device 250 is in communication with microcircuit 254 via wires 252. The dispenser 100 may comprise one or more such speakers, located in any convenient position within or on external housing 105. The microcircuit may contain for example a sound or series of sounds or one or more songs within its internal memory. These sounds or songs may be broadcast through the sound emitting device 250 upon the occurrence of certain events as will be described below.

The driving means 220 may also be electrically connected with microcircuit 254. Microcircuit 254 may be electrically connected to a switch 260, which in the embodiment shown in FIG. 2 is mounted on top of motor housing 222 and beneath or within storage space 210. Microcircuit 254, driving means 220, and sound emitting device 250 are each in communication with a power source, not shown, such as a battery, that provides power to each of these components.

Optional master switch 262 may be located within a recess 264 of outer housing 105. The master switch is electrically connected to the power source and the microcircuit 254 or driving means 220. The master switch 262 thus shuts off power to the active components including the driving means 220 and the sound emitting means 250 of dispenser 100 when set to the “off” position.

Microcircuit 254 may also provide a timing function for driving means 220 and sound emitting means 250. Upon activation of the switch 260, microcircuit 254 will continue to produce sound signals for broadcast by the sound emitting means 250 and to direct current to the driving means 220 for predetermined times, after which both the sound and motion will cease until switch 260 is activated again. The duration of the sound and motion caused by activating the switch 260 may always be constant, or it may vary each time the storage device is used. Also, the duration for the motion caused by driving means 220 may be the same as or different from the duration of the sound emitted by sound emitting means 250.

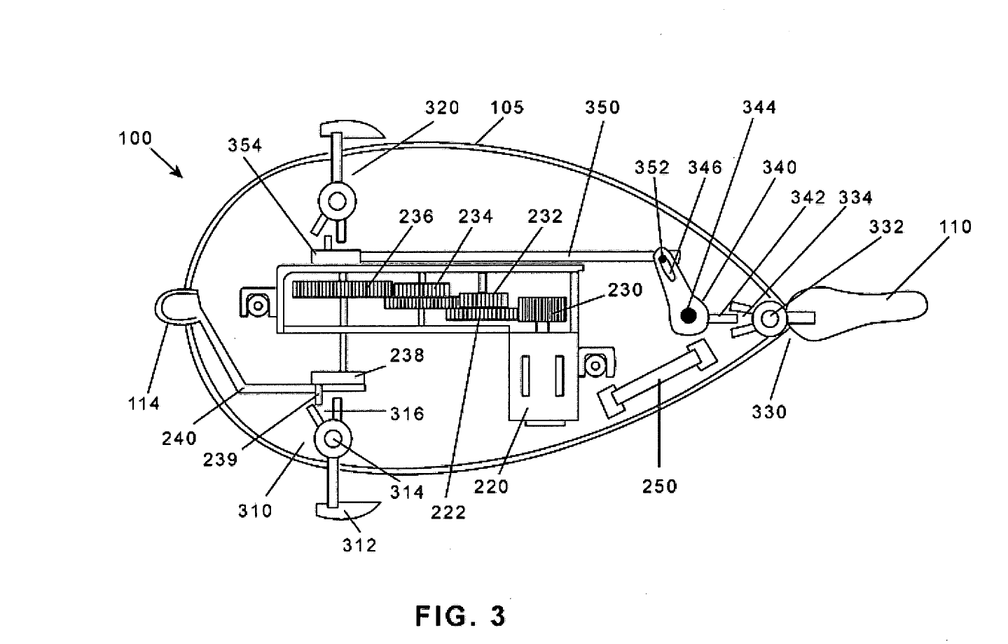

FIG. 3 is a top view of the dispenser 100 shown in FIGS. 1 and 2. Lips 114 and lever arm 240 are shown in communication with eccentric cam 238. Also shown are movable decorative elements including the side fin assembly 310, which is attached to side fin 312 and which may pivot around vertical fin pin 314, which is affixed to or in pivoting contact with the interior of outer housing 105. Fin driver pin 239 is attached to eccentric cam 238 and is situated in vertical channel 316 of fin assembly 310. As eccentric cam 238 rotates, cam pin 239 will scribe an arc that will effectively cause the cam pin 239 to move back and forth, alternately contacting the sides of channel 316, causing fin assembly 310 to pivot back and forth around vertical fin pin 314. This motion causes attached fin 312 to move back and forth relative to external housing 105, giving the appearance of a swimming motion with a flapping fin. Fin assembly 320 on the other side of storage device 100 operates in a similar manner to produce a similar flapping motion of the attached fin.

Driving means 220 is also employed to make the tail 110 move back and forth in a swimming motion. Tail 110 is attached to tail assembly 330, which pivots around vertical tail pin 332. Vertical tail pin 332 is affixed to or in pivoting contact with the interior of outer housing 105. Linkage 340 pivots around vertical linkage pin 344, which is affixed to or in pivoting contact with the interior of outer housing 105. Tail driver pin 342 is affixed to linkage 340 and is situated in vertical channel 334 of tail assembly 330. Linkage 340 may also include oblong channel 346.

Tail driver arm 350 is located along the side of motor housing 222. Vertical linkage driver pin 352 is affixed to the near end of tail driver arm 350 and projects into or through oblong channel 346 of linkage 340. The distal end of tail driver arm 350 is in communication with eccentric cam 354, which is in communication with driving means 220 via gears 230, 232, 234, and 236. When driving means 222 causes eccentric cam 354 to rotate, tail driver arm will move back and forth, towards and away from tail 110. Vertical linkage driver pin 352 will cause linkage 340 to pivot back and forth around vertical linkage pin 344. Tail driver pin 342 affixed to linkage 340 will also move back and forth, contacting the sides of vertical channel 334 of tail assembly 330 and causing tail 110 to move back and forth in a swimming motion.

The embodiment of the dispenser 100 shown in FIG. 2 may be used as follows: When the pump 122 is depressed to dispense fluid contained within the storage space 210, a switch 260 is activated. Activating switch 260 closes an electrical circuit which includes the sound emitting means 250, the driving means 220, the microcircuit 254, and the power source (of course, such activation assumes that the master switch 262 is in the on position). Microcircuit 254 causes one or more sounds to be produced by sound emitting device 250. The Microcircuit 254 also activates driving means 220, causing gears 230, 232, 234, 236, and eccentric cam 238 to rotate. Eccentric cam 238 presses against lever arm 240, causing the lip 114 to rise and fall in conformity with the shape of the cam 238 as it rotates. The driving means 220 also and causes the side fins 312 to flap, the tail 110 to move back and forth. Thus the fish-shaped storage device appears to “come alive” with sounds and swimming motions when the dispenser 100 is operated.

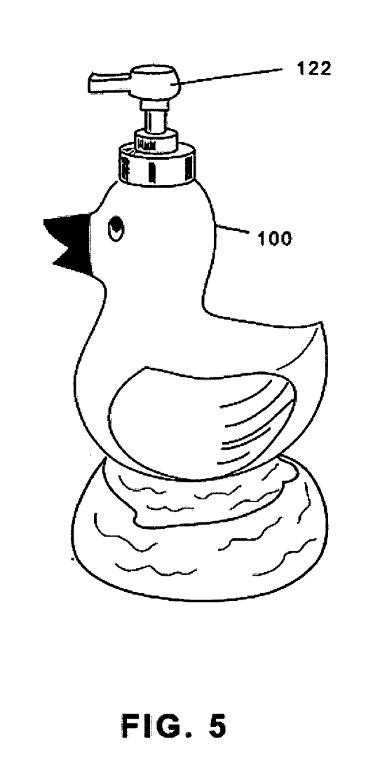

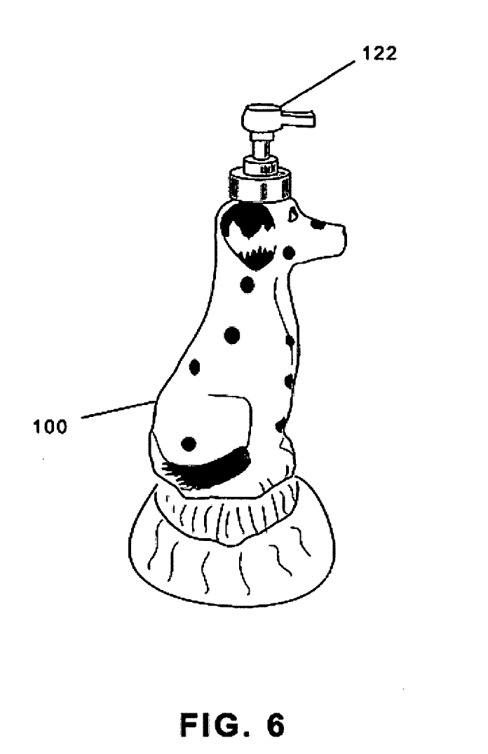

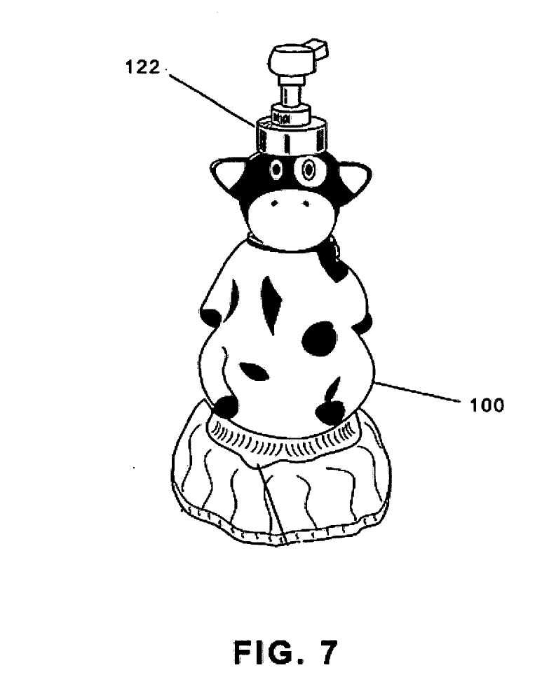

While the forgoing example has been described with respect to a fish, as shown in FIGS. 1-3, the invention is not so limited and may include for example, a duck, a dog, a cow or a monkey as shown in FIGS. 5-8.

Further, while the invention has been described in this embodiment with respect to a dispenser, it is to be understood that the invention can be used to hold or store any type of object or material, such as a toothbrush, a drinking glass, or the like. A switch 260 or other activating means can be placed in a suitable location in communication with the device so that it is depressed upon the insertion or removal of the object or material from the device.

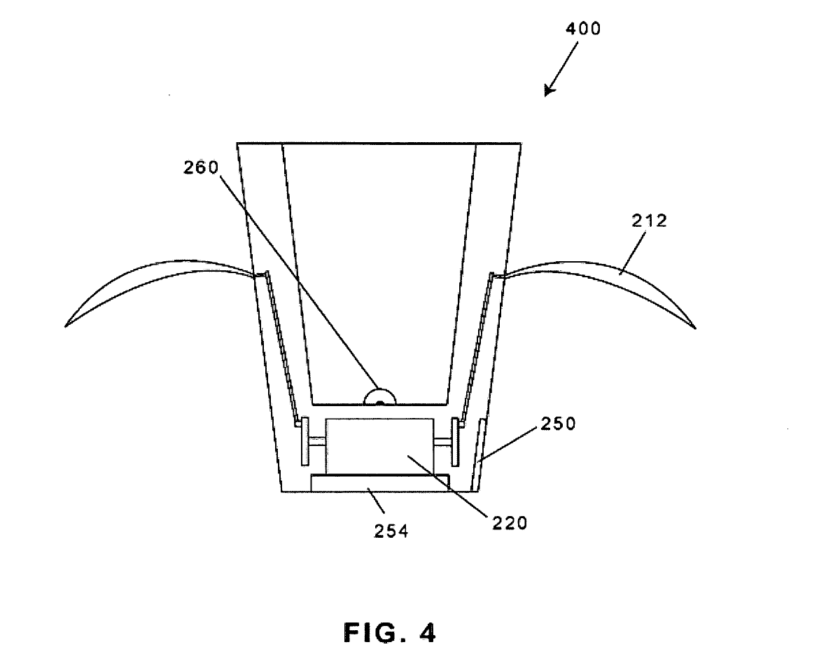

For example, in one embodiment of the present invention, the “dispenser” is a glass or tumbler, as shown in FIG. 4. In FIG. 4, the tumbler 400 includes an activation switch 260. In one embodiment the switch is pressure sensitive. When the tumbler is filled, the pressure sensitive activation switch 260 closes, causing an electrical circuit connecting the switch to the motor 220, the microcircuit 254, and the sound emitting device 250. The microcircuit may be programmed for example with a song, which is produced through the sound emitting device 250 upon closing of the activation switch 260. The closing of the activation switch 260 also causes the microcircuit to send power to the driving means 220. As shown in FIG. 4 the driving means 220 is a motor. Rotation of the motor causes the movable elements 212, in this case wings, to move or flap.

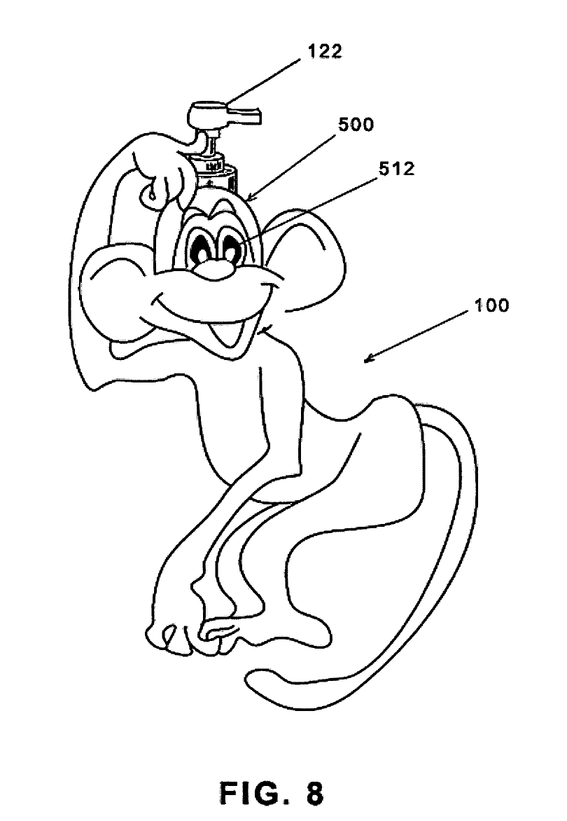

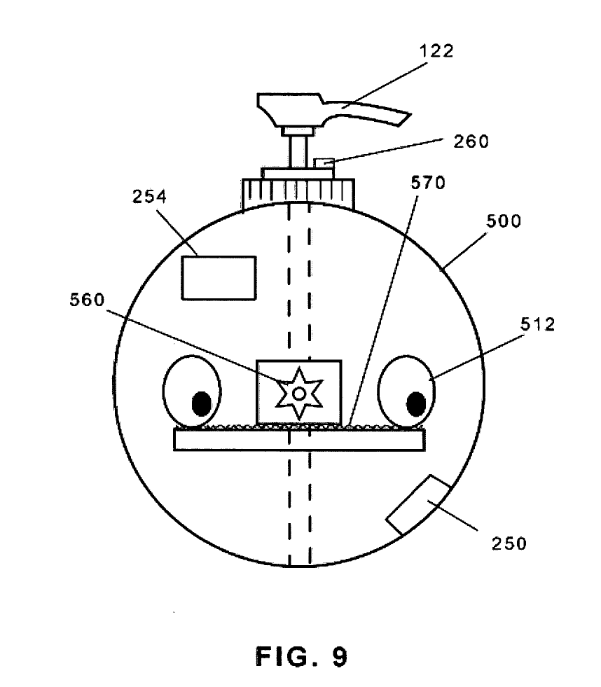

In another example of the present invention, the movable decorative element is the eyes 512 of a monkey 500, as shown in FIGS. 8 and 9. Upon a depression of the pump 122, the activation switch 260 is closed. Although shown in this example as exterior to the dispenser 100 the activation switch 260 may be located internal to the dispenser as described above. Upon depressing the activation switch 260, an electrical circuit is completed between the activation switch a microcircuit 254, and a sound emitting device 250. In the embodiment shown in FIG. 9, the microcircuit 254 causes the driving means 220, in this case a motor, to rotate. As the motor rotates in a first direction, a pinion gear 560 rotates. The pinion gear meshes with teeth on a rack 570 and move in a first direction. The movement of the rack 570 causes the movable decorative element, the eyes, to move in a first direction. In a preferred example of this embodiment, the motor is reversible and can be driven in a second direction. As the motor rotates in a second direction the pinion gear 560 causes the rack 570 to move in a second direction, which in turn causes the eyes to move in a second direction. A sound emitting device 250 is also connected to the microcircuit 254 and may cause sounds or a song to be emitted from the dispenser 100.

In a more general sense, the invention disclosed herein is a storage device comprising a housing capable of holding or storing one or more objects or substances, one or more movable decorative elements, a sound emitting means, and an activation means. The moveable decorative elements and sound-making elements are activated by the activation means when the storage device is used in a predetermined manner (i.e. depressing the pump 122 as discussed above).

The decorative movable elements are driven by driving means such as an electric motor, an electromagnet, or the like. The driving means may be powered by a power source such as one or more batteries, a stored source of mechanical energy such as a coiled spring, and/or one or more solar cells. The driving means may optionally comprise a motor controller that governs the power supplied to the moving means. The motor controller may be a microcircuit, a switch in communication with a mechanical timer, or the like. The motor controller may govern the duration that the motion element continues to move once activated or a sequence of movements performed by the motion element.

The driving means may, a shown above be in mechanical communication with one or more levers, cams, gears, wheels, or the like, that convert the motion of the driving means into other desired forms of motion, such as converting rotational motion to transnational motion.

The driving means is also in mechanical communication with one or more appendages or decorative movable elements. The one or more appendages are caused to move when the driving means is activated. The motion of the appendage may be linear, rotational, periodic, irregular, or a combination of these.

The sound emitting means may comprise a sound emitter such as a small speaker, a piezoelectric element, or a transducer. The sound emitting means may further comprise or be electrically connected to a computer chip or other microcircuit or microdevice capable of producing a sound through a sound emitter. The sound emitting means may further comprise an independent power source, which may be separate from the main power source for the device. The sound emitting means may alternatively be a mechanical device, such as a mechanical buzzer or the like.

The sound emitting means may further comprise a sound controller that governs the characteristics of the sound produced when activated. The sound characteristics may include the random or predetermined selection of a song or sound from a collection of such sounds stored in a memory component or subcomponent of a microcircuit, the duration and/or volume of the sound produced when the sound-making element is activated, or any other characteristics of the sound produced by the storage device. The sound controller may be a microcircuit, a computer chip, or the like. The sound controller may be the same as, or share components with, the motor controller.

The activation means for the storage device of the present invention may be a pressure-activated switch, a tilt sensor, or any other activation means that can activate the motion and sound-making elements. In some embodiments the switch may be a microswitch. In other embodiments, the activation means may comprise a VOX—a voice-activated (or sound-activated) switch. In yet further embodiments, the activation means may comprise a motion-detecting switch that can activate when an object is moved or a light-detecting switch that operates on detected amounts of ambient or direct light on the switch.

The invention may include sound emitting elements that are mechanical; for instance, a sound emitting device that emits a sound as a result of air being forced into or out of it (e.g., like a squeak or squeeze toy).

The device may also comprise one or more master switches capable of deactivating one or more of the sound-making means, motion means, or the activation means. The master switch can be a simple on/off switch that interrupts power to all electrical components of the storage device. Alternatively, the master switch can be configured to constrain the activation means to require certain external conditions to function. For instance, the master switch may be a light-sensitive switch that allows the motion and/or sound-making elements to be activated only when there is ambient light, and will prevent one or both of these elements from being activated when there is no light. As a specific example, the master switch can be configures such that if the storage device is in a relatively dark setting, such as a bathroom at night, it will generate motion but not emit a sound when used, but it will generate both sound and motion when there is light, such as during the day.

Use of the device to trigger the activation means may include placing one or more objects into or onto the storage device, or removing one or more objects from the storage device. Examples of uses of the device include insertion or removal of a toothbrush, a tumbler, a bar of soap, or chopsticks from the storage device, squeezing the storage device, withdrawing lotion or other liquid or foam from a dispenser located on or in the storage device, or the like. Activation may also comprise pressing down on a dispenser pump, where the pressure from activating the dispenser also activates a pressure-activated switch (e.g., a switch may be located below or next to the lotion container on or within the storage device, such that pressure from a user using the dispenser is transmitted to the switch to complete or break a circuit and thus activate the sound-making and motion elements).

One of skill in the art will appreciate that a device according to the present invention may comprise a plurality of activation means, wherein each activation means may correspond to a different action or use of a different object being stored. Each activation means may optionally cause a different sound to be produced and/or a different type of motion to occur. For example, in one embodiment the storage device may hold both a bar of soap and one or more toothbrushes. Separate microswitches or other activation means may be in communication with the separate compartments or storage areas used to hold the soap and toothbrushes. The storage device in this embodiment may play a particular song or generate a particular phrase when the soap is removed, and a different song or phrase when a toothbrush is removed.

When using objects stored within the device of the present invention, removing an object may serve as the activation means for emitting a sound or a predetermined motion, and returning the object to the storage device may deactivate one or both of these means. In such an embodiment, a controller may also be used to deactivate the device after a predetermined time as a backup, to prevent excessive use of the batteries or other power source.

The device in accordance with the instant invention may also be formed with at least part of the housing being transparent or translucent, and thus upon activation of the activation means, one or more light-emitting devices, such as an LED, may emit a light that can be seen by a user. One or more LED's or other light-emitting devices may also be provided directly visible to a user by being positioned on or adjacent to an external surface of the housing. It will be appreciated that the LED's or other light emitting elements are in electrical contact with a power source and may be controlled by a microchip or microcircuit.

The device of the present invention can be of any size, any shape and made from any material that is sufficiently rigid to provide a means of storing or holding a liquid or other object. Thus the material can be plastic, resin, metal, synthetic or natural material, and/or partly plastic and partly metal. Therefore, it can withstand repeated use by a user using it on a daily basis without breaking or cracking and at the same time it is sturdy enough to receive a container, a cup, a lotion bottle, a vase, and the like.

It is to be further understood that any utilitarian description herein of any component of the storage device of the invention, for example, the exterior of the housing or any feature thereon, or the nature and number of moving appendages and any feature thereon, is not to be constructed as a statement that the appearance of any component of the invention is functional in nature or dictated by function. Surface ornamentation or configuration of the storage device or any components thereof, for example, the exterior of the housing or the moving appendages, or any portion thereof, are attributable to ornamental considerations.

The device of the present invention can be sculptured and/or molded, e.g., blow-molding in any form or shaped as desired, for example, it can take a shape of an animal, a mammal, an insect, an inanimate object such as an airplane or an automobile, an amphibian such as a frog, or any animated cartoon characters.

Having thus described in detail preferred embodiments of the present invention, it is to be understood that the invention defined by the above paragraphs is not to be limited to particular details set forth in the above description, as many apparent variations thereof are possible without departing from the spirit or scope of the present invention.

I claim:

1. A dispenser comprising:
a decorative housing;
a fluid storage means internal to said decorative housing;
a fluid dispensing means in fluid communication with said fluid storage means;
one or more movable decorative elements;
activation means in communication with said fluid dispensing means; and
a sound emitting means, wherein upon operation of the fluid dispensing means fluid is dispensed from said fluid storage means and said activation means is triggered initiating said sound emitting means to produce sound and further initiating movement of said one or more moveable decorative elements.

2. The dispenser of claim 1, further comprising an energy storage device operably connected to said activation means.

3. The dispenser of claim 2, further comprising a driving means in mechanical communication with said one or more movable decorative elements.

4. The dispenser of claim 3, further comprising interconnected driving means in electrical connection with each other for independently driving said one or more movable decorative elements.

5. The dispenser of claim 1, wherein said activation means comprises one or more microswitches, electrical contacts, magnetic switches, pressure switches, tilt sensors, sound-activated switches, motion-detecting switches, or light-sensitive switches

6. The dispenser of claim 1, further comprising one or more movable decorative elements, wherein movement of said one or more moveable decorative elements is initiated by said fluid dispensing means.

7. The dispenser of claim 1, further comprising a master switch capable of deactivating one or more of the sound emitting means and the one or more movable decorative elements.

8. The dispenser of claim 7 wherein said master switch comprises a light-sensitive switch that energizes when in the presence of ambient or directed light and de-energizes when in the absence of ambient or directed light.

9. The dispenser of claim 1, further comprising one or more light-emitting elements configured to produce light upon activation of the activation means

10. A tumbler comprising:
a decorative housing;
a fluid storage means internal to said decorative housing;
one or more movable decorative elements;
activation means in communication with said fluid storage means; and a sound emitting means, wherein upon providing fluid to the fluid storage means said activation means is triggered initiating said sound emitting means to produce sound and further initiating movement of said one or more moveable decorative elements.
